(19) United States
(12) Patent Application Publication
(10) Pub. No.: US 2007/0117450 A1
(43) Pub. Date: May 24, 2007

(54) Novel jack form LED lamp package and caddy

(76) Inventor: William W. Truxes, Park City, UT (US)

Correspondence Address: William W. Truxes III, 947 Northstar Dr., PO Box 4077, Park City, UT, 84060-4077, US

(21) Appl. No.: 11/299,019

(22) Filed: Nov. 18, 2005

(51) Int. Cl. H01R 3/00

(52) U.S. Cl. 439/490

(57) ABSTRACT

A unique LED lamp package is disclosed that can receive a plug (42), make electrical connection in a circuit (39) and cast radiant energy (125) (UV, visible, IR or a combination) in at least one direction rendering objects in that direction visible, hereinafter referred to as a jacklamp (100, 101, 200, 201, 202). In one embodiment (100) the components of a jacklamp, consisting of at least one LED die (120), a controller (110), and an interconnecting lead frame (147), are encapsulated in transparent polymer (400) shaped with a recess (142) to receive a plug (42) and direct radiation (125). In another jacklamp embodiment (201), a commercial off the shelf (COTS) jack (250), a controller (110), and at least one COTS LED (300), are interconnected by a lead frame (147) and encased in a molded polymer package (500). Plug a compatible bus cable into a jacklamp and direct or observe its illumination. A jacklamp will task light areas limited only by the cable length, provide indication of the health of a cable circuit, and identify a single cable in a bundle. In the absence of another bus powering device, the caddy, provides a means of independently powering a jacklamp or a prior art bus pluglamp, besides providing convenient and secure transportation and storage.

### CROSS-REFERENCE TO RELATED APPLICATIONS

This application claims the benefit of provisional patent application Ser. No. 60/630,497, filed 2004 Nov. 11 by the present inventor.

### FEDERALLY SPONSORED RESEARCH

Not Applicable

### REFERENCE TO A MICROFICHE APPENDIX

Not Applicable

### BACKGROUND OF THE INVENTION

This invention relates in general to Light Emitting Diode (LED) lamp packages, and in particular to a novel jack form LED lamp illuminator package, hereinafter referred to as a jacklamp, and a caddy for it.

A LED package is known in the trade to consist of, at least one electrical energy to radiant energy transducer die (e.g. a LED, an organic LED (OLED) or laser diode (LD)), a lead frame (i.e. a metal skeletal structure utilized to electrically connect, cool by thermal conduction, and support the transducer die.) and a cast transparent polymer encapsulant, forming the device enclosure and its integrated optics. When provided with externally controlled electrical energy through a lead frame, a LED package emits radiant energy (UV, visible, IR or a combination) in at least one direction, rendering objects in that direction visible for illuminator applications or making itself visible to observers in that direction for indicator applications.

A LED lamp package is known in the trade to be a LED package with internal electrical energy control for the transducer (e.g., integral current limiting resistors for 5 and 12 volt systems).

A majority of LED packages and LED lamp packages are designed to be received by a printed circuit board (PCB) for permanent solder connection thereto, usually either in standard cast-epoxy, through-hole type (THT) or surface mount type (SMT) configurations. Some illuminate displays, most are used as indicators in signs, signals, electronic equipment front panels, switches, and connectors. These packages are confined to the PCB at fabrication.

All other LED lamp packages, known to me at this time, are of a plug morphology, hereinafter referred to as a pluglamp.

A male connector is known in the trade as a plug and is designed to be received by a female connector to make an electrical connection in a circuit. A female connector is known in the trade as a jack, a socket, a receptacle or a port. Normally female connectors are fixed on devices and plugs are free to move on the ends of connecting cables, until received by and fastened to a female connector. Some miniature devices, as light or lighter than a cable, use fixed plugs and eliminate the cable.

A pluglamp is assembled from at least one LED package with external current control or at least one LED (or LD) lamp package an internal current regulator, and a plug base designed to be received by a female connector to make electrical connection in a circuit that provides power for pluglamp operation.

Most pluglamps (e.g., an Edison, screw or threaded base, as shown in FIG. 4A, a Swan, lug or bayonet base, as shown in FIG. 4B, and conventional automotive wedge base, as shown in FIG. 4C) are designed to be used in existing AC or DC powered devices to replace incandescent lamps, exemplified in U.S. Pat. Nos. 4,211,955 to Ray (1980), 4,358,708 to Silva et al. (1982), 4,630,183 to Fujita (1986), 4,727,289 to Uchida (1988), 6,371,636 to Wesson (2000), 6,621,716 to Edwards et al. (2003), and others. Pluglamps are confined to the socket or receptacle that powers and supports them.

Some pluglamps, as shown in FIG. 4D, are designed to be received by a computer peripheral bus port, to make an electrical connection in a computer circuit, drawing power therefrom, to emit and cast visible radiant energy in at least one direction to render objects in that direction visible, hereinafter referred to as bus pluglamps.

A few examples of the many standard computer peripheral buses that may provide power for operation and recharging of peripherals via cable are: Apple Desktop Bus (ADB), Universal Serial Bus (USB), IEEE 1394 bus (Firewire), and IEEE 802.3af or Power-over-Ethernet (PoE) bus. Hereinafter the terms, system, peripheral, bus, cable, plug, jack, socket, receptacle and port, all shall refer to one of these buses and any other or future bus or buses which may provide power, data and control signals to their peripherals by way of a single cable.

These buses, recognized to be of enduring and growing value, have become ubiquitous in computer, instrument, industrial control, automotive, aviation, and consumer electronics systems. USB enabled devices alone “shipped 1.4 billion . . . by end of 2001” (source: www.usb.org), and are projected to be “growing to 3.5 billion [shipped] by 2006” (source: Cahners InStat Group, March 2002).

The earliest bus pluglamp, U.S. Pat. No. 5,615,945 to Tseng (1997), is a desk lamp (for illuminating a computer display, keyboard, and nearby objects) powered by a laptop computer port (“an electric socket of the computer”), for when an AC outlet is not convenient or available for a regular desk lamp. This bus pluglamps, short flexible neck, between its plug and its incandescent light bulb, provided electrical connections to power the lamp and support for positioning it. A short (0.05 to 0.5 meters) flexible neck style (first seen in U.S. Pat. No. 1,651,307 to Wilkinson (1927)) is common to most variants of the Tseng bus pluglamp today, with many descendants simply replacing the incandescent light bulb with a LED, as exemplified in U.S. Pat. Nos. 6,428,177 to Naghi et al. (2002), 6,527,409 to Naghi et al. (2003), 6,575,593 to Krietzman (2003), 6,680,844 to Kim (2004), 6,749,314 to Naghi et al (2004), and others.

Illuminated displays and keyboards have reduced the utility of bus pluglamps to lighting nearby objects (i.e., confined to within the half meter neck length, of a receiving computer port).

Many battery operated peripheral devices, reduce the number of cables portable computer users need to carry by using the same cable for operation and recharging via port or power adapter-chargers, e.g. an AC/DC adapter-charger, a vehicle power adapter-charger (VPA) or an automotive IDB-1394 Customer Convenience Port (CCP). Bus pluglamps may be received by these power adapter-chargers, but are limited again to providing light only within a half meter of an AC wall outlet, a VPA or a CCP.

A need exists for a bus powered lamp that will illuminate objects beyond the half meter limit of a bus pluglamp (e.g., behind or under a desk or airline seat, inside a desk drawer or an airline bag, in and around an auto, a desk top computer, a server rack or a consumer electronics cluster) for system setup, trouble shooting and repair in low or no light conditions.

Billions of cables are available for peripherals that may be only used occasionally (e.g., with portable computers or portable devices shared between systems). For convenience cables are often left connected, even when the peripheral is not. These cables compete with bus pluglamps for a systems limited number of ports and must be inconveniently swapped out, piggybacked or adapted (i.e., use a cable plug to bus pluglamp plug adapter).

Absent from the art is a jack form LED lamp illuminator package that can receive a terminal plug from one of these cables and provide task lighting to an area only limited by the length of the cable used.

### BRIEF SUMMARY OF THE INVENTION

Accordingly, it is an object of this invention, a unique jack form LED lamp illuminator package (hereinafter referred to as a jacklamp), to solve the aforementioned limited reach lighting problem of prior art pluglamps and bus pluglamps, by replacing the plug with a jack, so a jacklamp user may replace the bus pluglamps, short flexible neck, with any length cable they may have on hand, thereby extending task lighting to an area only limited to that length (e.g., behind or under a desk or airline seat, inside a desk drawer or an airline bag, in and around an auto, a desk top computer, a server rack or a consumer electronics cluster).

It is another object of the jacklamp to utilize the billions of cables on hand to provide task lighting in computer, instrument, industrial control, automotive, aviation, and consumer electronics systems, for setup, trouble shooting and repair in low or no light conditions.

It is another object and advantage of the jacklamp, that its radiant output can be fixed by an integral circuit or actively controlled via cable signals.

It is another object and advantage of the jacklamp, that its radiant output is at optimum brightness on power-up for either the fixed or the active control but with the active control the radiant energy may be turned off, dimmed or modulated thereafter, via cable signals.

It is another object and advantage of the jacklamp is that it can be used to determine the health of just the host and cable power circuit, when the jacklamp control is passive via a fixed circuit.

A further object and advantage of the jacklamp is that it can be used to determine the health of the whole host and cable circuit, when the jacklamp control is active via cable signals.

It is another object and advantage of the jacklamp, that it can receive a plug on a remote or out of sight cable end (i.e., in another room or building), to identify a single cable in a bundle.

It is another object and advantage of the jacklamp, that it can be used on a cable powered by either a port, jacklamp caddy, or a power adapter-charger, e.g. an AC/DC adapter-charger, a vehicle power adapter-charger (VPA) or an automotive IDB-1394 Customer Convenience Port (CCP).

It is another object and advantage of the jacklamp, that when a powered port or a power adapter-charger is unavailable, it can be used on a portable, powered, storage and transportation accessory device, hereinafter referred to as a jacklamp caddy, to provide portable hand held task lighting.

It is another object and advantage of the jacklamp, that it can be used with the jacklamp caddy and a cable to provide portable extended task lighting.

It is another object and advantage of the jacklamp, that it can be used with the jacklamp caddy to test a cables power circuit.

It is another object and advantage of the jacklamp, that it can be used with the jacklamp caddy to identify a single cable in a bundle.

It is another object and advantage of the jacklamp, that it can be stored on the jacklamp caddy while the jacklamp caddy is being used to power a prior art bus pluglamp or another jack lamp on a cable.

It is also an object of the jacklamp to provide an improved illuminating device of the type described hereinafter which is simple and inexpensive to manufacture, highly useful, easily transportable, economical and convenient to use.

Still further objects and advantages of my jacklamp will become apparent from consideration of the drawings and ensuing description.

### BRIEF DESCRIPTION OF THE DRAWINGS

It to be understood that the components shown in the following figures are not necessarily to scale, with emphasis instead being placed upon illustrating the principles of the jacklamp. In the drawings, closely related figures and reference numerals have the same number but different alphabetic suffixes.

FIG. 1A is a schematic block diagram of the jacklamps preferred cast package embodiment about to be connected to a powered bus cable.

FIG. 1B is a schematic block diagram of the jacklamps second preferred cast package embodiment, connected to a powered bus cable, thereby emitting radiant energy.

FIG. 2A is a schematic block diagram of the jacklamps preferred COTS embodiment, powered by the connected powered bus cable, thereby emitting radiant energy.

FIG. 2B is a schematic block diagram of the jacklamps second preferred COTS embodiment.

FIG. 2C is a schematic block diagram of the jacklamps third preferred COTS embodiment.

FIG. 3A is a schematic block diagram of a jacklamp caddy used as a jacklamp carrier.

FIG. 3B is a schematic block diagram of a jacklamp caddy used with a jacklamp as a task light.

FIG. 3C is a schematic block diagram of a jacklamp caddy used with a cable and a jacklamp as an extended task light or a remote cable identifier or a cable tester.

FIG. 4A is a pictorial representation of a prior art Edison base pluglamp.

FIG. 4B is a pictorial representation of a prior art Swan base pluglamp.

FIG. 4C is a pictorial representation of a prior art conventional automotive wedge base pluglamp.

FIG. 4D is schematic block diagram of an exemplary prior art bus pluglamp.

FIG. 5A is a schematic circuit diagram of a prior art LED lamp using an integrated circuit (IC) for bus variable current control.

FIG. 5B is a schematic circuit diagram of a prior art LED lamp using a resistor for fixed current control.

FIG. 5C is a schematic circuit diagram of a prior art LED lamp using a current limiting diode (CLD) for fixed current control.

FIG. 5D is a schematic circuit diagram of a prior art basic CLD.

FIG. 5E is a schematic circuit diagram of a prior art higher current CLD.

FIG. 5F is a schematic circuit diagram of another prior art even higher current CLD.

FIG. 5G is a schematic circuit diagram of another prior art very high current CLD.

REFERENCE NUMERALS IN DRAWINGS

| | |
|---|---|
| 1 | switch 52 NO contact |
| 2 | switch 52 NC contact |
| 3 | Direction to engage |
| 4a | Pluglamp, Edison type |
| 4b | Pluglamp, Swan type |
| 4c | Pluglamp, wedge type |
| 5 | LED lamp 5a, 5b or 5c |
| 5a | Lamp circuit, IC type |
| 5b | Lamp circuit, R type |
| 5c | Lamp circuit, CLD type |
| 6 | Plug, Edison type base |
| 7 | Plug, Swan type base |
| 8 | Plug, wedge type base |
| 9 | Neck or cable |
| 10 | Bus pluglamp |
| 30 | Bus powering device |
| 31 | Port, bus powered |
| 39 | Powered bus cable |
| 40 | Plug, upstream |
| 41 | Cable |
| 42 | Plug, downstream |
| 45 | Plug contacts |
| 50 | Jacklamp Caddy |
| 51 | Caddy power source |
| 52 | Caddy switch |
| 53 | Caddy plug |
| 54 | Caddy jack |
| 55 | Caddy lead frame |
| 56 | Caddy case |
| 100 | Jacklamp 1A |
| 101 | Jacklamp 1B |
| 110 | Control, IC |
| 114 | Current limiting resistor |
| 115 | CLD |
| 115d | CLD, basic circuit |
| 115e | CLD high current |
| 115f | CLD higher current |
| 115g | CLD greater current |
| 116 | CLD alternate symbol |
| 120 | Transducer (EERE) |
| 125 | Radiant energy (RE) |
| 142 | Plug Recess |
| 145 | Jack contacts |
| 147 | Lead frame |
| 148 | COTS LED lamp leads |
| 200 | Jacklamp 2A |
| 201 | Jacklamp 2B |
| 202 | Jacklamp 2C |
| 250 | COTS jack |
| 275 | LED lamp package |
| 300 | COTS LED package |
| 400 | Cast package |
| 410 | Cast Optics |
| 500 | Molded package |

### SUMMARY

In accordance with the present invention a jack form LED lamp illuminator package comprises a jack form package capable of receiving a bus plug; an electrical energy to radiant energy transducer (e.g., a LED, OLED, or LD); a transducer controller; and a lead frame to connect the bus plugs power and signal contacts to the controller and transducer, thereby generating and casting radiant energy (UV, visible, IR or a combination) in at least one direction rendering objects in that direction visible. Accordingly an accessory caddy to power, store and transport the invention comprises a power source; a carrier plug; a jack, a case and a switch to apply the power to either the jack or the plug.

### DETAILED DESCRIPTION OF THE PREFERRED EMBODIMENTS

In the following discussion of the drawings it is noted that while the descriptions are cast primarily in general terms of standard peripheral buses, the invention (hereinafter referred to as a jacklamp) may conform to and be used in conjunction with any number of different buses well known in the art, that provide power and perhaps control signals for operation and recharging of peripherals via a cable, exemplified by, but not limited to, the Apple Desktop Bus (ADB), the Universal Serial Bus (USB), the IEEE 1394 bus (Firewire), and the IEEE 802.3af or Power-over-Ethernet (PoE) bus. Hereinafter all peripheral bus terms (i.e. bus, cable, plug, jack, etc.) shall refer to one of these buses.

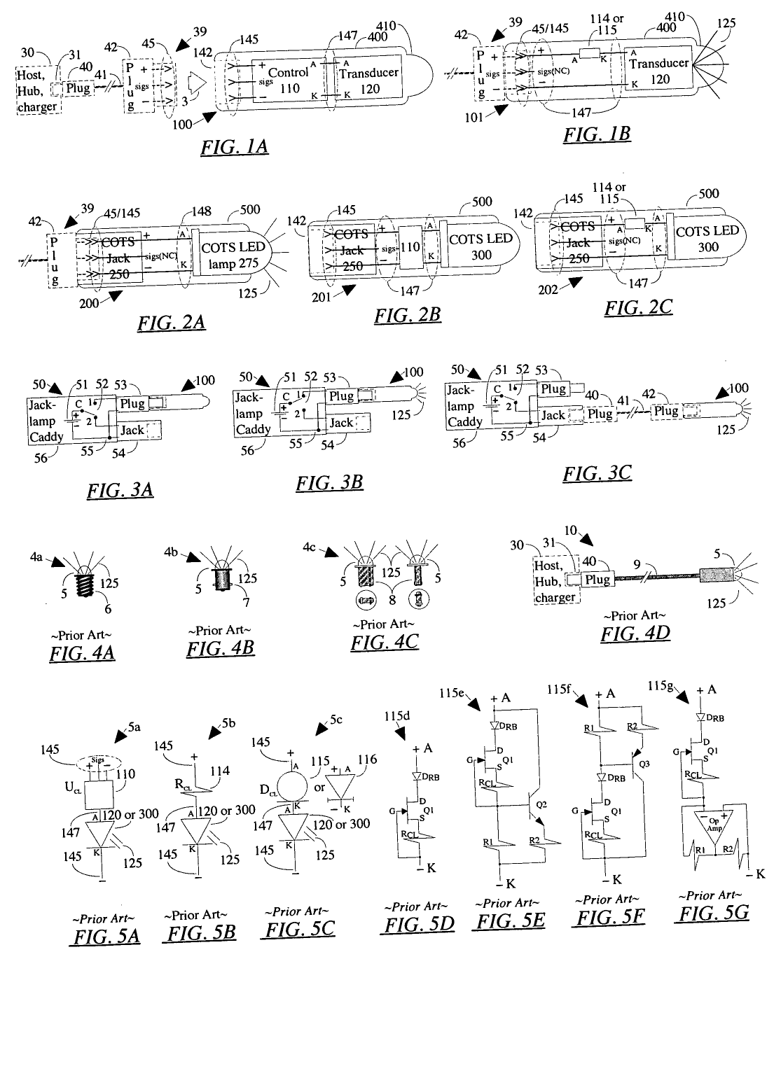

### Cast Embodiments—FIGS. 1A and 1B

FIG. 1A illustrates the jacklamps preferred cast package embodiment 100 about to be connected with a powered bus cable 39.

The preferred cast embodiment jacklamp 100 comprises a component encapsulating, transparent, cast-polymer package 400 having integral cast optics 410 and a recess 142 formed to receive (from direction of arrow 3) the downstream plug 42 of a powered bus cable 39; a plurality of jack contacts 145 in the packages 400 plug recess 142 to make electrical connections between the downstream plug 42 contacts 45 (.plus., . minus., and signals) and the integrated circuit electrical energy control die 110; a lead frame 147 (i.e. a metal skeletal structure) utilized to electrically connect, cool by thermal conduction, and support the transducer die 120 and its control die 110; a control die 110 to (when powered) actively control the electrical energy to at least one transducer die 120 via the lead frame 147; and at least one electrical energy to radiant energy transducer die 120 to (when powered) emit radiant energy 125 (not shown) from the jacklamp 100 through its cast integral optics 410.

The powered bus cable 39 (not a part of the invention, but must necessarily cooperate with it by providing power and perhaps control signals thereto) is a cable (i.e. an upstream plug 40, connected via a plurality of conductors 41 to a downstream or terminal plug 42) attached to a bus powering devices 30 jack 31.

The bus powering device 30 provides the signals and the electrical energy to operate the jacklamp 100 and may be, but is not limited to, a peripheral bus interface in a host computer, a powered bus hub, a Commercial Electronics (CE) device, an AC/DC adapter/charger, an automotive IDB-1394 Customer Convenience Port (CCP), a vehicle power adapter/charger (VPA), or a jacklamp caddy 50 (shown in FIGS. 3A, 3B, and 3C).

The package 400 casting material selection and fabrication, is well understood in the art, and accordingly will not be described further herein.

The fabrication and assembly of the transducer die 120 and the control die 110 to the lead frame 147, is well understood in the art, and accordingly will not be described further herein.

The control 110 of the jacklamp 100 is an integrated circuit (IC), which provides controlled electrical energy or current to the transducer 120, based on the voltage and signals received via the jacklamp contacts 145 (like circuit 5a shown in FIG. 5A) from an engaged powered bus cable 39.

The transducer 120, is an electrical energy to radiant energy (EERE) converter, exemplified by a light emitting diode (LED), an organic LED (OLED) or a laser diode (LD), and may have (when powered as shown in FIG. 1B) an output radiant energy 125. Hereinafter radiant energy 125 shall refer to radiant energy of any wavelength (UV, visible or IR) or combination of wavelengths available to the art.

The cast integral optics 410 may form lenses, filters, mirrors or any combination of these elements to spatially control the jacklamps 100 emitted radiation 125, and may be cast entrained with phosphors or nanoparticles (quantum dots or photonic bandgap structures) for spectral control to, for example, photoluminescently downconvert a blue or UV emitting transducer 120 to white radiant energy 125.

FIG. 1B illustrates the jacklamps second preferred cast package embodiment 101 connected 45/145 (i.e. plug 42 contacts 45 to jacklamp 101 contacts 145), to a powered bus cable 39, thereby emitting radiant energy 125.

This jacklamp 101 differs from the previous jacklamp 100 only in the method of current control used to drive the transducer 120.

Instead of using variable, bus controlled current via IC 110 (circuit 5a shown in FIG. 5A), this jacklamp 101 uses fixed current control provided by either a current limiting (or ballast) resistor 114 (circuit 5b shown in FIG. 5B) or a current limiting diode (CLD) 115 (circuit 5c shown in FIG. 5C). CLDs are also known as constant current diodes (CCD) and have an alternate schematic symbol 116.

It is known in the art that EERE transducers 120 are best driven by a fixed constant current source. Constant current drives, to varying degrees, automatically compensate for variations of supply voltage, component parameters and operating temperature.

The simplest and lowest component cost, fixed current control is a ballast resistor 114, however this method is subject to the aforementioned variations that adversely effect the jacklamps 101 performance and limit its application. A ballast resistor 114 is a fixed constant current control only if its operating conditions are constant.

A variable ballast resistor, that adjusts to supply voltage, temperature and device parameter variations, is known as a CLD 115. FIG. 5D, is exemplary of a basic prior art CLD 115d circuit. A CLD 115 is a two terminal (i.e. A for anode and K for cathode) semiconductor circuit that behaves as a variable ballast resistor in series with a diode, to automatically maintain a constant current through itself and any component in series with it (e.g. a transducer 120 or LED 300 as seen in FIG. 5C). Within its range it can compensate for supply voltage, device to device parameters (like LED forward voltage) and temperature induced variations. FIGS. 5E (circuit 5e), 5F (circuit 5f) and 5G (circuit 5g), are exemplary of other prior art CLD 115 circuits for higher and higher constant currents.

### COTS Embodiments—FIGS. 2A, 2B and 2C

FIG. 2A illustrates the jacklamps preferred Commercial Off The Shelf (COTS) embodiment 200 connected 45/145 (i.e. plug 42 contacts 45 to jacklamp 200 contacts 145), to a powered bus cable 39, thereby emitting radiant energy 125.

The preferred COTS embodiment jacklamp 200 comprises a molded polymer package 500 encapsulating at least two components; a COTS jack 250 to receive the downstream plug 42 of a powered bus cable 39 to make electrical connections 45/145 between the downstream plug 42 contacts 45 (.plus. and .minus.), the jack 250 contacts 145 (.plus. and .minus.) and the leads 148 (A and K) of a COTS LED lamp 275; and at least one COTS LED lamp 275 to emit radiant energy 125.

The package 500 molding material selection and fabrication, is well understood in the art, and accordingly will not be described further herein.

FIG. 2B illustrates the jacklamps second preferred Commercial Off The Shelf (COTS) embodiment 201.

The second preferred COTS embodiment jacklamp 201 comprises a molded polymer package 500 encapsulating at least three components; a COTS jack 250 to receive the downstream plug 42 contacts 45 (.plus., . minus., and signals) and electrically connect them to the lead frame 147 via its contacts 145 (.plus., . minus., and signals); a lead frame 147 (i.e. a metal skeletal structure) utilized to electrically connect, cool by thermal conduction, and support a COTS jack 250, a current control 110, and a COTS LED 300; a variable (i.e. based on the bus voltage and signals) current control 110 (circuit 5a shown in FIG. 5A) to provide (when powered) controlled current to at least one COTS LED 300 via the lead frame 147; and at least one COTS LED 300 to (when powered) emit radiant energy 125 (not shown).

The COTS LED 300 packages shown in FIGS. 2B, and 2C are THT, however they may be of any package type (e.g. SMT, etc.) available to the art.

FIG. 2C illustrate the jacklamps third preferred Commercial Off The Shelf (COTS) embodiments 202.

The third preferred COTS embodiment jacklamp 202 comprises a molded polymer package 500 encapsulating at least three components; a COTS jack 250 to receive the downstream plug 42 contacts 45 (.plus., . minus.) and electrically connect them to the lead frame 147 via its contacts 145 (.plus., . minus.); a lead frame 147 (i.e. a metal skeletal structure) utilized to electrically connect, cool by thermal conduction, and support a COTS jack 250, a fixed current control 114, 115 and a COTS LED 300; at least one fixed current control 114 (circuit 5b, FIG. 5B), 115 (circuit 5c, FIG. 5C) to provide a constant current to the COTS LED 300; and at least one COTS LED 300.

### Jacklamp Caddy Embodiment—FIGS. 3A, 3B and 3C

FIGS. 3A, 3B and 3C, illustrates that the caddy 50 switches 52 power 51 either to its plug 53 or its jack 54.

The preferred embodiment of a jacklamp caddy 50 comprises a power source 51 (e.g. a battery as shown or perhaps a super capacitor not shown); a single pole double throw (SPDT) switch 52 with its common C connected to the energy sources 51 positive terminal (.plus.) via a lead frame 55; a plug 53 with its power contact connected to the switches 52 normally open (NO) contact 1 and its ground contact connected to the energy sources 51 negative terminal (.minus.) via a lead frame 55; a jack 54 with its power contact connected to the switches 52 normally closed (NC) contact 2 and its ground contact connected to the energy sources 51 negative terminal (.minus.) via a lead frame 55; a lead frame 55 (i.e. a metal skeletal structure) utilized to electrically connect, and support the power sources 51 terminals, the switch 52, the plug 53 contacts, and the jack 54 contacts; and a case 56 to contain and support these components. The switch may be any mechanical or electronic switch available in the art.

### Operation—FIGS. 1A, 1B, 2A, 2B, and 2C

All jacklamp embodiments 100, 101, 200, 201 and 200, illustrated in these figures, receive a plug 42 from a powered bus cable 39 or a plug 53 from a caddy 50, draw power therefrom to produce radiant energy 125. Hereinafter jacklamp 100 shall refer to any and all jacklamp embodiments 100, 101, 200, 201 and 200.

FIGS. 1A and 2B illustrate jacklamps 100 and 201 that do more than just emit radiant energy when plugged into. Both of these embodiments use not just the bus power of the plug 42, but also the bus signals, via the IC control 110. This bus controlled current would allow the jacklamps 100 radiant energy output 125 or brightness to be controlled by a host computer 30 in many ways, from simple on/off, scheduled on/off, and dimming, to perhaps modulated light communications. It is contemplated that these bus controlled jacklamps 100, 201 could have an initial state of optimum brightness on power-up and be turned off, dimmed or modulated thereafter.

### Jacklamp Caddy Operation—FIGS. 3A, 3B and 3C

The caddy 50 accessory not only carries or stores a jacklamp 100 on its plug 53, but also provides power and enables independent use of a jacklamp 100 (or a prior art bus pluglamp 10), in the absence of a bus powering device 30, i.e. the caddy 50 becomes a bus powering device 30.

FIG. 3A illustrates the use of a jacklamp caddy 50 as a convenient and secure transportation and storage accessory, with the jacklamp 100 on the unpowered plug 53.

FIG. 3B illustrates the use of a jacklamp caddy 50 as a hand held task light, with the jacklamp 100 on the powered plug 53, emitting radiant energy 125.

FIG. 3C illustrates the use of a jacklamp caddy 50 as an extended task light, with the jacklamp 100 on a cable 40, 41, 42 connected to the powered jack 54, emitting radiant energy 125. This configuration may be used to test the cables power circuits, find a single cable in a bundle, or power a prior art bus pluglamp 10 (not shown) connected to the powered jack 54 as a task light.

### CONCLUSION, RAMIFICATION, AND SCOPE OF THE INVENTION

Accordingly, the reader will see that the jacklamp of this invention provides, what has been absent from the art, a jack form LED lamp illuminator package that can receive a terminal plug from one of the billions of aforementioned powered cables and task light an area limited only by the length of the cable, for setup, trouble shooting and repair in low or no light conditions, in and around, computer, instrument, industrial control, automotive, aviation, and consumer electronics systems. In addition the jacklamp caddy of this invention not only provides a convenient and secure transportation and storage accessory for a jacklamp, but also in the absence of another bus powering device, provides a means of independently powering a jacklamp or a prior art bus pluglamp, that has not been available in the art. Furthermore, the jacklamp has additional advantages in that
it permits radiant output to either be fixed by an integral circuit or actively controlled via cable signals;
it allows either fixed or actively controlled radiant output or brightness to be optimum initially on power-up and turned off, dimmed or modulated thereafter by an active control.
it permits the testing of a host and cable power circuit;
it permits the testing of the entire host and cable circuit, under bus control;
it permits identification of a single host cable in a bundle;
it may be used on a cable powered by a host port, a jacklamp caddy or a power adapter-charger;
it provides portable hand held task lighting when used on a jacklamp caddy;
it provides extended task lighting when used with a cable on a jacklamp caddy;
it allows testing of a cable power circuit between it and a jacklamp caddy; and
it allows identification of a single cable in a bundle, between it and a jacklamp caddy.

While my above description contains many specificities, these should not be construed as limitations on the scope of the invention, but rather as an exemplification of preferred embodiments thereof. Many other variations are possible. For example, the jack of the invention could be one that receives a cable plug from an A.C. plug-in power supply, as used to recharge or power portable devices (e.g. cell phones, digital cameras, radios, etc.). One brand of A.C. plug-in power supply offers 21 changeable plug tips (Adaptaplug®—A thru U). Each of these plug tips have two prongs opposite the power plug, to mate with its power cable jack. A jacklamp could also have two prongs to mate with this style power supply cable; the jack of the invention may be one that receives a plug from the plain old telephone system (POTS) know to have run power over its lines to hundreds of millions of sites for decades; the jacklamp of FIG. 2A may not include a COTS jack and instead may form the COTS LED lamp leads to function as jack leads in the molded case; the COTS LED lamp and the COTS LED packages shown FIGS. 2A, 2B and 2C are THT, however they may be of any package type (e.g. SMT, etc.) available to the art; the radiant energy could be cast in a direction other than coaxial to the jacklamp or could be adjustable; the outer surface of a jacklamp may have cast or molded in grips and an attaching method or system (i.e. grips, clips, magnets, suction cups, reusable adhesive, gecko tape (van der Waals bonds) or velcro, etc.); the jacklamps of FIGS. 1A and 2B could contain multiple independently controlled radiant energy emitters with different wavelengths for different functions, i.e. UV (for fluorescence checking, money checking, credit card checking, criminology, oil-mining, mineralogy, archeology, surveillance, chemical probe testing, security links, document checking, biology, medical applications , chemistry, food checking, water pollution detection, etc.), visible (for task lighting, signaling, alignment, etc.) and IR (for control or communications, e.g. IrDA protocol, voice, etc.); the jacklamps of FIGS. 1A and 2B could also contain a radiant energy to electrical energy transducer interfaced with the control IC, enabling it to receive as well as transmit modulated light signals in a full duplex mode (e.g. IrDA protocol, voice, etc.), etc.

Accordingly, the scope of the invention should be determined not by the embodiments illustrated, but by the appended claims and their legal equivalents.

I claim:

1. A jack form LED lamp package capable of receiving a cable plug, drawing power therefrom to provide task lighting at the end of the cable, said jack form LED lamp package comprising:
at least one transducer of electrical energy to radiant energy, said transducer of electrical energy to radiant energy being a device selected from the group consisting of light emitting diodes or LEDs and organic light emitting diodes or OLEDs and laser diodes or LDs, said radiant energy being at least one wavelength or color selected from the group consisting of ultraviolet or UV and visible and infrared or IR;
at least one controller to regulate power to said transducer, said controller being a device selected from the group consisting of fixed power regulation controllers and manually variable power regulation controllers and electronically variable power regulation controllers;
a lead frame to electrically connect the transducer, the controller, and form a plurality of contacts;
a transparent package encapsulating the transducer, the controller and said lead frame, with a recess to receive a plug; and
said plurality of contacts protrude into the said recess to make electrical connections to said plugs circuit contacts, and therefrom receiving power and signals, to cause the transducer to emit radiant energy for task lighting.

2. The jack form LED lamp package of claim 1, further comprising an on/off switch for each of the transducers.

3. The jack form LED lamp package caddy stores, transports, and powers, either directly or through a connecting cable, a jack form LED lamp package, said jack form LED lamp package caddy comprising:
at least one plug form to carry the jack form LED lamp package;
at least one jack form to receive a cable plug;
at least one power source terminal form to receive power source terminals;
a lead frame to form contacts in said plug form, in said jack form and in said power source terminal form to electrically connect them together; and
a case composing the plug form, the jack form, and the power source terminal form encapsulating said lead frame.

4. The jack form LED lamp package caddy of claim 2, further comprising an on/off switch for each of the jacks and the plugs.
